(19) United States
(12) Patent Application Publication
(10) Pub. No.: US 2013/0257722 A1
(43) Pub. Date: Oct. 3, 2013

(54) TIME INFORMATION ACCEPTING APPARATUS, TIME INFORMATION ACCEPTING METHOD, COMPUTER PROGRAM AND RECORDING MEDIUM

(71) Applicant: Koji Sato, Osaka-shi (JP)

(72) Inventor: Koji Sato, Osaka-shi (JP)

(73) Assignee: SHARP KABUSHIKI KAISHA, Osaka-shi, Osaka (JP)

(21) Appl. No.: 13/993,905

(22) PCT Filed: Dec. 14, 2011
(86) PCT No.: PCT/JP2011/078863

§ 371 Date: Jun. 13, 2013

(30) Foreign Application Priority Data
Dec. 14, 2010 (JP) 2010-278515

(51) Int. Cl. G06F 3/033

(52) U.S. Cl. CPC G06F 3/033
USPC 345/157

(57) ABSTRACT

It is expected to provide a time information accepting apparatus and the like, which can accept time information by an intuitive and simple operation without a slide bar. A time information accepting apparatus, accepting time information by detecting a movement operation of a coordinate point in a predetermined coordinate system, has a determining means for determining a unit quantity of time corresponding to a moving amount of a coordinate point in the predetermined coordinate system by calculating a moving amount and/or moving speed of a coordinate point due to a first operation, a calculating means for calculating a moving amount of a coordinate point due to a second operation, and a time information determining means for determining time information based on the moving amount calculated by the calculating means and the unit quantity determined by the determining means.

This application is the national phase under 35 U.S.C. §371 of PCT International application No. PCT/JP2011/078863 which has an International filing date of Dec. 14, 2011 and designated the United States of America.

### FIELD

The present invention is related to a time information accepting apparatus and a time information accepting method for accepting time information by detecting movement of a coordinate point in a predetermined coordinate system, a computer program for implementing the time information accepting method with a computer, and a recording medium that records the computer program.

### BACKGROUND

Recently, some portable equipment is implemented which mounts the GUI function with a liquid crystal touch panel and can play the contents, such as a motion image and a music. Generally, the portable equipment utilizes a slide bar to accept time information for specifying a forward position, a rewind position and a play position in the content. The slide bar is configured with a line section and a pointer, while the line section has a start point and an end point and the pointer moves on the line section. The slide bar is displayed on a display screen. A user of the portable equipment can operate the pointer with a pointing device, to specify a relative time-position on a set time axis.

On the other hand, 1 Japanese Patent Application Laid-Open No. 2000-231431 discloses a GUI utilizing a bended line type slide bar that is configured with a bended line for dealing with an image data interactively and intuitively and configured with a coordinate specifying means moving on the bended line. Thus, it is possible to implement such an interactive operation in which a path course of an object in image data is traced.

### SUMMARY

However, the slide bar must be displayed on the display screen of the GUI in the conventional portable equipment when the time information is accepted. Thus, it is difficult for equipment whose screen region size is small, to configure a GUI having a higher operability. For example, when a play operation is performed with a slide bar displayed in a small space on a display screen for a content whose play time is longer, it is difficult to perform an operation for a fine time adjustment in seconds or the like. It may be considered to display a button for changing the time scale on the display screen of the GUI, in order to implement the operation for the fine time adjustment. However, it will cause more difficulty for the GUI's configuration. Even if such a button is prepared, the operability is deteriorated because it is difficult to operate the button displayed in a small space. When the slide bar is configured in a hardware manner, similar problem will be caused in the small equipment for accepting the time information.

Although it may be considered in the GUI in Japanese Patent Application Laid-Open No. 2000-231431 that an operation can be performed, for example, to interactively deal with a path course of a target object, it is assumed that such an operation is performed after the object is visually recognized. Such a method may have an impact for an operation onto a specific content with respect to a play operation regarding a motion image on a touch panel. However, the visual recognition is not always required for a general play of a motion image. Hence, it may require other method suitable to the play operation regarding the motion image, more generally.

In addition, the technique of Japanese Patent Application Laid-Open No. 2000-231431 assumes sequential operations based on the context of the content. Thus, it is not configured for a general purpose. It is not always applied to an optional content. Furthermore, it is not suitable for an interface required to promptly jump to a desired point on the time axis.

The present invention is made in view of such circumstances, and an object is to provide a time information accepting apparatus, a time information accepting method, a computer program and a recording medium, in which time information can be accepted by an intuitive and simple operation, without utilizing a slide bar.

A time information accepting apparatus according to the present invention is a time information accepting apparatus that accepts time information by detecting a movement operation of a coordinate point in a predetermined coordinate system, comprising a determining means for determining a unit quantity of time corresponding to a moving amount of a coordinate point in the predetermined coordinate system, by calculating a moving amount and/or moving speed of a coordinate point due to a first operation, a calculating means for calculating a moving amount of a coordinate point due to a second operation, and a time information determining means for determining time information based on the moving amount calculated by the calculating means and the unit quantity determined by the determining means.

The time information accepting apparatus according to the present invention has the predetermined coordinate system that is a plane coordinate system.

The time information accepting apparatus according to the present invention has the coordinate point that is specified by an input device.

The time information accepting apparatus according to the present invention has the first operation and the second operation that are a series of movement operations of the coordinate point in the predetermined coordinate system.

The time information accepting apparatus according to the present invention has the first operation that is a linear type movement operation of the coordinate point in the predetermined coordinate system.

The time information accepting apparatus according to the present invention has the second operation that is a curvilinear type movement operation of the coordinate point in the predetermined coordinate system.

The time information accepting apparatus according to the present invention has the second operation that is a movement operation in a circular or arcuate manner of the coordinate point in the predetermined coordinate system.

The time information accepting apparatus according to the present invention has the moving amount of the coordinate point due to the second operation that includes an amount representing an angle of a start point and an end point for a moved coordinate point with respect to a center of a circle or an arc.

The time information accepting apparatus according to the present invention has the moving amount of the coordinate point due to the second operation that includes an amount representing an orbiting frequency of the coordinate point.

The time information accepting apparatus according to the present invention has the moving amount of the coordinate point due to the second operation that is increased or decreased in accordance with a moving direction of the coordinate point due to the second operation.

The time information accepting apparatus according to the present invention has the calculating means that is configured to store a moving vector of the coordinate point moved by the second operation or an angle of a start point and an end point for a moved coordinate point with respect to a center of a circle or an arc successively, and to calculate the moving amount based on stored plural moving vectors or angles.

The time information accepting apparatus according to the present invention has the calculating means that is configured to calculate the moving amount of the coordinate point due to the second operation after the unit quantity is determined.

The time information accepting apparatus according to the present invention has the calculating means that is configured to calculate the moving amount of the coordinate point due to the second operation before the unit quantity is determined.

The time information accepting apparatus according to the present invention has the calculating means that is configured to store a coordinate point being moved by the second operation successively, and to calculate the moving amount based on stored plural coordinate points.

The time information accepting apparatus according to the present invention has the moving amount of the coordinate point due to the first operation in the predetermined coordinate system is a distance between a start point and an end point of the moved coordinate point.

The time information accepting apparatus according to the present invention further comprises a displaying means having a display surface corresponding to the predetermined coordinate system, and a means for storing a resolution of the displaying means, wherein the determining means is configured to determine the unit quantity based on the moving amount or the moving speed of the coordinate point due to the first operation and on the resolution of the displaying means.

The time information accepting apparatus according to the present invention comprises a displaying means having a display surface corresponding to the predetermined coordinate system, and a means for storing information regarding an actual size of the display surface of the displaying means, wherein the determining means is configured to determine the unit quantity based on the moving amount or the moving speed of the coordinate point due to the first operation and on the information regarding the actual size of the display surface.

The time information accepting apparatus according to the present invention has the determining means that is configured to determine the unit quantity being longer as the moving amount or the moving speed of the coordinate point due to the first operation is larger.

The time information accepting apparatus according to the present invention has the determining means that is configured to determine the unit quantity being shorter as the moving amount or the moving speed of the coordinate point due to the first operation is larger.

The time information accepting apparatus according to the present invention further comprises a means for displaying a length of the unit quantity determined by the determining means or time regarding the time information determined by the time information determining means.

The time information accepting apparatus according to the present invention has the unit quantity of time corresponding to the moving amount of the coordinate point in the predetermined coordinate system that is calculated successively while the coordinate point is moved by the first operation in the predetermined coordinate system, and has the calculated unit quantity that is displayed.

The time information accepting apparatus according to the present invention has time information that is calculated successively based on the moving amount and the unit quantity of the coordinate point, while the coordinate point is moved by the second operation in the predetermined coordinate system, and has the calculated time information that is displayed.

The time information accepting apparatus according to the present invention has time information for specifying a rewind position, a forward position and a play position with respect to a motion image play that is accepted.

A time information accepting method according to the present invention accepts time information by detecting a movement operation of a coordinate point in a predetermined coordinate system, and comprises a determining step of determining a unit quantity of time corresponding to a moving amount of a coordinate point in the predetermined coordinate system, by calculating a moving amount and/or moving speed of a coordinate point due to a first operation, a calculating step of calculating a moving amount of a coordinate point due to a second operation, and a time information determining step of determining time information based on the moving amount calculated in the calculating step and the unit quantity determined in the determining step.

A computer program according to the present invention makes a computer, detecting a movement operation of a coordinate point in a predetermined coordinate system, function as a determining means for determining a unit quantity of time corresponding to a moving amount of a coordinate point in the predetermined coordinate system, by calculating a moving amount and/or moving speed of a coordinate point due to a first operation, a calculating means for calculating a moving amount of a coordinate point due to a second operation, and a time information determining means for determining time information based on the moving amount calculated by the calculating means and the unit quantity determined by the determining means.

A recording medium according to the present invention is computer-readable and records the computer program described above.

In the present invention, the time scale in the predetermined coordinate system is determined based on the moving amount and/or moving speed of the coordinate point due to the first operation. The time scale is the unit quantity of time corresponding to the moving amount of the coordinate point in the predetermined coordinate system. Then, the time information is determined based on the moving amount of the coordinate point due to the second operation and on the time scale. Therefore, the time information is accepted by the first operation and the second operation in the predetermined coordinate system.

The pointing device according to the present invention is not required to display a GUI part, such as a slide bar, on the screen. In addition, it is not required to prepare a hardware mechanism for the slide bar. Therefore, the present invention is suitable to equipment whose allocable hardware resources are limited, such as a remote controller, too.

It should be noted that the time information accepting apparatus according to the present invention may be implemented by a computer. It is possible to implement the time information accepting apparatus by making the computer work as each means contained in the time information accepting apparatus. In addition, the present invention includes the computer program that makes the computer work as each means, and includes the recording medium that records the computer program.

In the present invention, the predetermined coordinate system is a plane coordinate system. The coordinate point in the plane coordinate system can be operated by a pointing device, such as a planer touch panel.

In the present invention, the coordinate point is specified by the input device.

In the present invention, the time information is accepted by the first operation and the second operation that configure a series of movement operations. Therefore, a user of the pointing device according to the present invention can input the time information as if the user utilizes in an unicursal style. Hence, it is possible to implement an understandable and convenient method for accepting the time information.

In the present invention, the time scale is accepted by the linear type movement operation.

In the present invention, the time information in the time scale is accepted by the curvilinear type movement operation.

In the present invention, the time information in the time scale is accepted by the movement operation in the circular or arcuate manner of the coordinate point.

In the present invention, the moving amount of the coordinate point and time information are determined with the angle of the start point and the end point for the moved coordinate point with respect to the center of circle or arc.

In the present invention, the moving amount of the coordinate point and time information are determined with the orbiting frequency of the coordinate point due to the second operation.

In the present invention, the time information is increased or decreased in accordance with the moving direction of the coordinate point due to the second operation. For example, the time information increases when the coordinate point moves clockwise, and the time information decreases when the coordinate point moves anticlockwise.

In the present invention, the moving vector of moving coordinate point due to the second operation is stored successively, and the moving amount of the coordinate point and time information are determined in accordance with the stored plural moving vectors for the coordinate point. Similarly, the angle of coordinate point with respect to the center of circle or arc is stored successively, and the moving amount of the coordinate point and time information are determined in accordance with the stored plural angles.

In the present invention, the moving amount of the coordinate point due to the second operation is calculated after the time scale is determined.

In the present invention, the moving amount of the coordinate point due to the second operation is calculated before the time scale is determined.

In the present invention, the coordinate point is stored successively while it is being moved by the second operation, and the time information is determined with the stored plural coordinate points.

In the present invention, the moving amount of the coordinate point due to the first operation is a distance between the start point and the end point of the moved coordinate point. Therefore, if the reciprocating movement is caused on the coordinate point in the middle of movement, the unit quantity of time is determined by the distance between the finally decided start point and end point.

In the present invention, the time scale is determined based on the moving amount or moving speed of the coordinate point due to the first operation and on the resolution of the displaying means.

In the present invention, the time scale is determined based on the moving amount or moving speed of the coordinate point due to the first operation and on the actual size of the display surface.

In the present invention, the time scale becomes larger as the moving amount or moving speed of the coordinate point due to the first operation is larger.

In the present invention, the time scale becomes smaller as the moving amount or moving speed of the coordinate point due to the first operation is larger.

In the present invention, the determined time scale or time regarding the determined time information is displayed.

In the present invention, the unit quantity of time is displayed even under the condition where the coordinate point is being moved by the first operation.

In the present invention, the time regarding the time information is displayed even under the condition where the coordinate point is being moved by the second operation.

In the present invention, the time information is accepted for specifying the rewind position, the forward position and the play position in the play of motion image.

According to the present invention, it is possible to accept time information by the intuitive and simple operation, without the slide bar.

The above and further objects and features will more fully be apparent from the following detailed description with accompanying drawings.

### BRIEF DESCRIPTION OF THE DRAWINGS

FIG. 1 is a perspective view that shows an example configuration of a time information accepting apparatus according to a present embodiment.

FIG. 2 is a block diagram that shows an example configuration of the time information accepting apparatus.

FIG. 3 is a block diagram that shows an example configuration of a time operation processing unit.

FIG. 4 is a flowchart that shows a procedure regarding a time information accepting method according to the present embodiment.

FIG. 5 is a flowchart that shows the procedure regarding the time information accepting method according to the present embodiment.

FIG. 6 is a flowchart that shows the procedure regarding the time information accepting method according to the present embodiment.

FIG. 7 is an explanation view that shows a method of forward operation for a motion image.

FIG. 8 is an explanation view that shows an operation method for determining a time scale.

FIG. 9 is an explanation view that shows a method of input operation for time information.

FIG. 10 is an explanation view that shows an operation method for rewinding the motion image.

FIG. 11 is an explanation view that shows a reciprocating linear movement operation performed when the time scale is inputted.

FIG. 12 is an explanation view that shows a reciprocating curvilinear movement operation performed when the time information is inputted.

FIG. 13 is a flowchart that shows a procedure regarding a time information accepting method according to an alternative embodiment 1.

FIG. 14 is an explanation view that shows an operation for setting the time scale.

FIG. 15 is an explanation view that shows the operation for setting the time scale.

FIG. 16 is a block diagram that shows an example configuration of a time operation processing unit according to an alternative embodiment 2.

FIG. 17 is a block diagram that shows an example configuration of a time operation processing unit according to an alternative embodiment 3.

FIG. 18 is a flowchart that shows a procedure regarding a time information accepting method according to an alternative embodiment 4, especially a procedure for displaying the time scale.

FIG. 19 is an explanation view that shows a method for displaying the time scale.

FIG. 20 is an explanation view that shows the method for displaying the time scale.

FIG. 21 is a flowchart that shows a procedure regarding the time information accepting method according to the alternative embodiment 4, especially a procedure for displaying the time information.

FIG. 22 is an explanation view that shows a method for displaying the time information.

FIG. 23 is an explanation view that shows the method for displaying the time information.

FIG. 24 is a flowchart that shows a procedure regarding a time information accepting method according to an alternative embodiment 5.

FIG. 25 is an explanation view that shows an operation for specifying a play start position.

FIG. 26 is an explanation view that shows the operation for specifying the play start position.

FIG. 27 is a flowchart that shows a procedure for playing motion image data.

FIG. 28 is a perspective view that shows an example configuration of a time information accepting apparatus according to an alternative embodiment 6.

FIG. 29 is an explanation view that shows an operation for inputting time information.

FIG. 30 is a perspective view that shows an example configuration of a time information accepting apparatus according to an alternative embodiment 7.

FIG. 31 is an explanation view that shows an operation for inputting time information.

FIG. 32 is a block diagram that shows an example configuration of a remote operation apparatus according to an alternative embodiment 8.

FIG. 33 is a block diagram that shows an example configuration of a time information accepting apparatus according to an alternative embodiment 9.

### DETAILED DESCRIPTION

The present invention is explained below in detail, in reference with drawings showing embodiments of the present invention.

### <Time Information Accepting Apparatus>

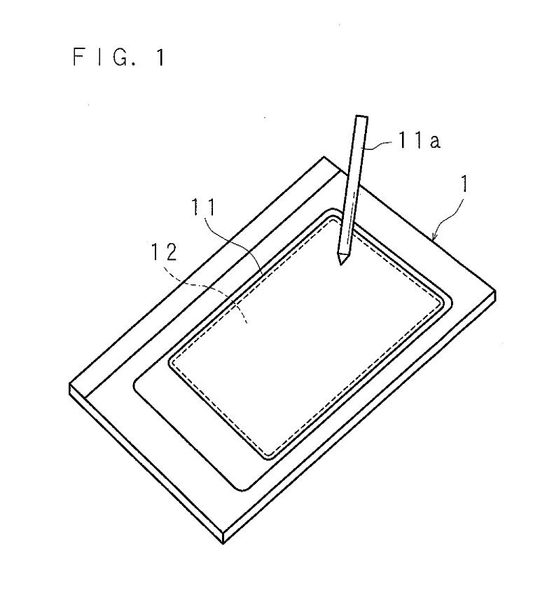

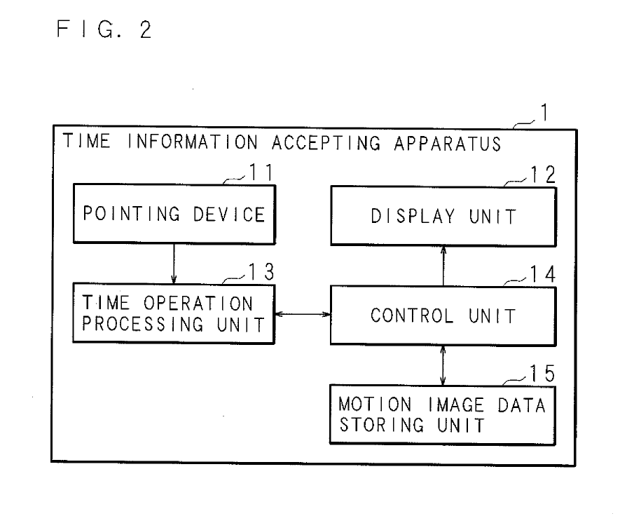

FIG. 1 is a perspective view that shows an example configuration of a time information accepting apparatus 1 according to a present embodiment. FIG. 2 is a block diagram that shows an example configuration of the time information accepting apparatus 1. The time information accepting apparatus 1 according to the embodiment of the present invention includes a pointing device 11, a display unit 12, a time operation processing unit 13, a control unit 14 and a motion image data storing unit 15. The time information accepting apparatus 1 is to detect and interpret a content of user's operation, and then to determine the time information for performing a play operation onto a motion image or the like. The configuration of time information accepting apparatus 1 is described under the assumption that it is a functional module mounted in the target equipment. However, the configuration is not always required. The time information accepting apparatus 1 may be implemented as the single built-in-type equipment. In the present embodiment, it is explained below on the assumption that the time information accepting apparatus 1 is a pad-type tablet terminal having a function for playing a motion image.

The pointing device 11 is an input device for inputting a coordinate value on a predetermined plane surface in a predetermined coordinate system, such as a plane coordinate system. For example, it is an input device, such as a transparent touch panel applied on the front surface of the display unit 12, a touch pad, a pen tablet, a pointing stick, a joy stick, a ball point mouse, a mouse, a trackball, and a lightpen. In the present embodiment, it is explained about the case that a touch panel is operated with a stylus pen 11a as shown in FIG. 1. The predetermined plane surface corresponds to the display surface of the display unit 12. The pointing device 11 detects the input event, such as contact of the stylus pen 11a to the touch panel, the position where the stylus pen 11a comes into contact, and the like. Then, the pointing device 11 outputs the input event data representing the detected event and coordinate value data representing the detected position, toward the time operation processing unit 13. Hereinafter, the input event data and the coordinate value data are called as operation information.

The display unit 12 is a device for displaying several information, for example, regarding a played motion image, and contents of play operation for the motion image. For example, the display unit 12 is a touch panel type display, and is configured with a liquid crystal display panel, an organic electroluminescent panel, a LED display, a plasma display, a projector, an electric paper or the like.

The time operation processing unit 13 is a functional module that obtains the operation information outputted from the pointing device 11, processes the obtained operation information to determine the time information, for example, representing time regarding the forward operation and rewind operation for the played motion image, and outputs the determined time information. In addition, the time operation processing unit 13 outputs other event data, coordinate value data and the like among the obtained operation information, directly to the control unit 14, which are not required for determining the time information. The detail of time operation processing unit 13 is explained later.

The control unit 14 is a functional module that processes the operation information and controls the performance of each element in the information accepting apparatus 1. For example, the control unit 14 is a microcomputer having a CPU (central processing unit). In the present embodiment, the control unit 14 has functions for playing the motion image data stored in the motion image data storing unit 15 and displaying it on the display unit 12. The control unit 14 adequately outputs the control signals to the time operation processing unit 13 to make it perform the required processes for determining the time information, and obtains time information outputted from the time operation processing unit 13, operation information outputted from the pointing device 11 through the time operation processing unit 13, and the like. The control unit 14 performs processes specified by the obtained time information and process's content, and makes the display unit 12 display the process result. For example, it performs the forward process, rewind process or the like for the motion image, outputs the information for displaying the forwarded or rewound motion image toward the display unit 12, and makes the display unit 12 display the information regarding the motion image. In addition, the control unit 14 outputs information for displaying the GUI utilized for the basic operation, operation content and the like, toward the display unit 12, and makes the display unit 12 display them.

The motion image data storing unit 15 is a storage device that stores motion image data. For example, it is a magnetic disk, such as hard disk and flexible disk, a semiconductor memory, an optical disk, or a magneto-optical disk.

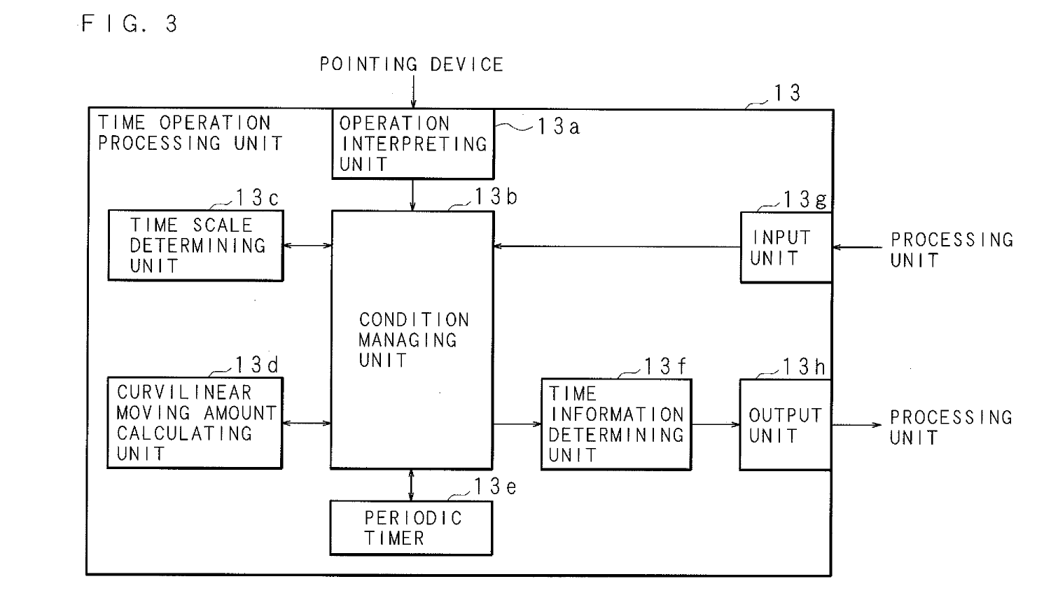

FIG. 3 is a block diagram that shows an example configuration of the time operation processing unit 13. The time operation processing unit 13 includes an operation interpreting unit 13a, a condition managing unit 13b, a time scale determining unit 13c, a curvilinear moving amount calculating unit 13d, a periodic timer 13e, a time information determining unit 13f, an input unit 13g and an output unit 13h.

The operation interpreting unit 13a has functions for interpreting whether the operation information outputted from the pointing device 11 is an object of the time information accepting process or not, based on the operation information, and for adequately making the condition managing unit 13b store the inputted operation information. In other words, the operation interpreting unit 13a internally and firstly judges whether the operation information is treated as the object of the time information accepting process or not, and sequentially outputs the next operation information to the condition managing unit 13b after identifying the trigger event, to perform the data notification for the internal processes regarding the time information acceptance.

The condition managing unit 13b is a functional module that performs a condition management and an event control required for the time information accepting process. The condition managing unit 13b not only stores the operation information outputted from the operation interpreting unit 13a successively, but also notifies the operation information to the time scale determining unit 13c and the curvilinear moving amount calculating unit 13d, to control the processes for determining the time information amount. In addition, when obtaining information for determining the time information from the time scale determining unit 13c and the curvilinear moving amount calculating unit 13d, the condition managing unit 13b outputs the data to the time information determining unit 13f to make it determine the time information. It should be noted that the condition managing unit 13b is configured to obtain the control signal outputted from the control unit 14 through the input unit 13g, and is the object element directly controlled by the control unit 14. The condition managing unit 13b has functions for resetting the condition based on the control signals outputted from the control unit 14, and the like.

The time scale determining unit 13c is a functional module for determining the time scale. It detects and processes the user's first operation, i.e., the linear movement operation of the coordinate point (hereinafter referred to as specified point) specified by the user on the predetermined plane surface, to determine the unit quantity of time corresponding to the moving amount of the specified point on the predetermined plane surface corresponding to the display surface of the display unit 12. The specified point on the predetermined plane surface means a point where the stylus pen 11a comes into contact with the touch panel. Hereinafter, the point where the stylus pen 11a comes into contact with the touch panel is called as the specified point. The time scale determining unit 13c detects and processes the linear movement operation for the specified point among the user's operations, based on the operation information sequentially stored in the condition managing unit 13b, in order to determine the time scale. Then, the time scale determining unit 13c stores the condition data representing the condition that the time scale has been determined, and the data representing the time scale. The time scale determining unit 13c outputs the condition data and the data representing the time scale to the condition managing unit 13b, in accordance with the control instruction obtained from the condition managing unit 13b.

The curvilinear moving amount calculating unit 13d is a functional module for determining the length of the specified point having moved curvilinearly after the linear movement operation. It detects and processes the user's second operation, i.e., the curvilinear movement operation of the specified point on the predetermined plane surface, to calculate the curvilinear moving amount of the specified point. The curvilinear moving amount calculating unit 13d detects and processes the circular motion among the user's operation, to calculate and store the curvilinear moving amount for the circular motion. Then, the curvilinear moving amount calculating unit 13d outputs the data representing the curvilinear moving amount to the condition managing unit 13b, in accordance with the control instruction from the condition managing unit 13b. The judging process for the circular motion of the specified point on the predetermined plane surface is performed by calculating the angular velocity, the moving vector and the like based on the historical information for the coordinate value data of the specified point stored in the condition managing unit 13b. While the circular motion is continued for the specified point, the movement of specified point is detected at any time and the orbiting number of the circular motion is counted. The curvilinear moving amount calculating unit 13d determines whether the circular motion is continued with periodically referring to the coordinate value data stored in the condition managing unit 13b. When the circular motion is stopped, it confirms the curvilinear moving amount and outputs the data representing the curvilinear moving amount to the condition managing unit 13b.

The periodic time 13e is a functional module for notifying the timing to the condition managing unit 13b, as the timing is for periodically detecting the coordinates of the specified point on the predetermined plane surface. The performance of the periodic timer 13e is controlled by the condition managing unit 13b. The periodic timer 13e starts clocking in accordance with the control instruction from the condition managing unit 13b. Each time when clocking a predetermined time, the periodic timer 13e outputs the signal to the condition managing unit 13b. The condition managing unit 13b can periodically detects the coordinates of the specified point by referring to the signal outputted from the periodic timer 13e.

The time information determining unit 13f determines the time displacement information based on the information obtained from the condition managing unit 13b. At that time, it confirms the final content of time displacement by applying the obtained time scale and the displacement amount into an arithmetic expression prepared internally, and notifies to the output unit 13h.

The input unit 13g is an internal signal interface for receiving a control instruction from the control unit 14. The input unit 13g is configured with a serial, parallel or bus interface, or the like, which is for connecting to the CPU implementing each functional module, such as the condition managing unit 13b.

The output unit 13h is an internal signal interface for outputting the time information and the like to the control unit 14. The output unit 13h is configured with a serial, parallel or bus interface, or the like, which is for connecting to the CPU.

### <Time Information Accepting Method>

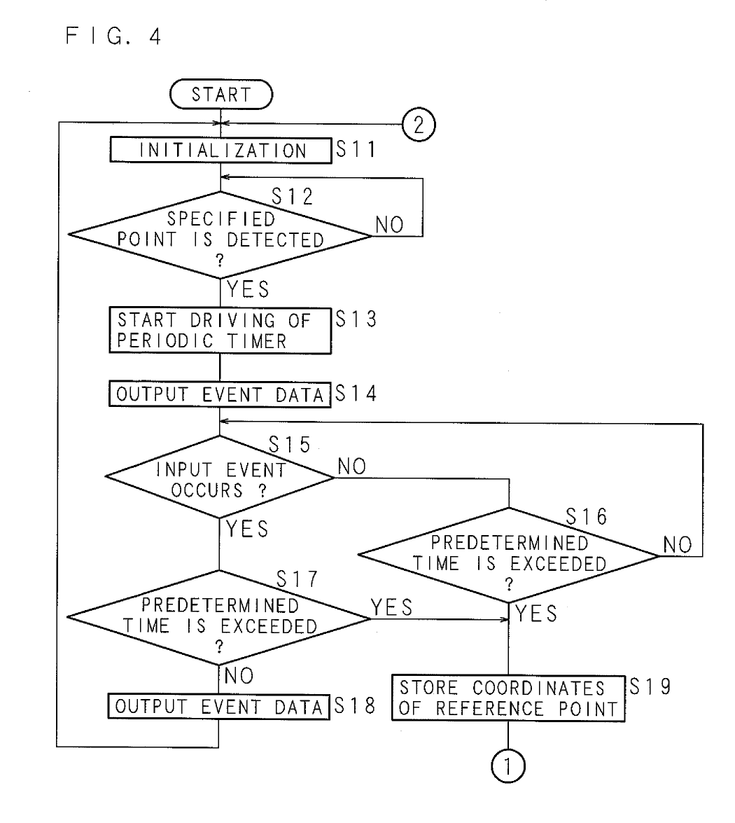

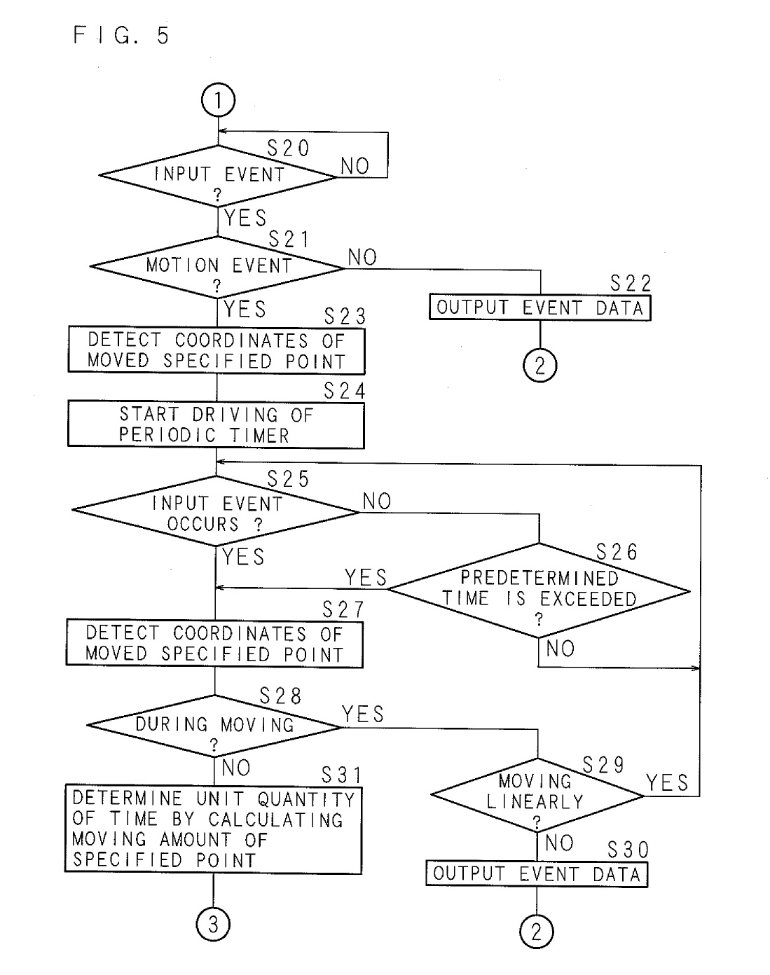

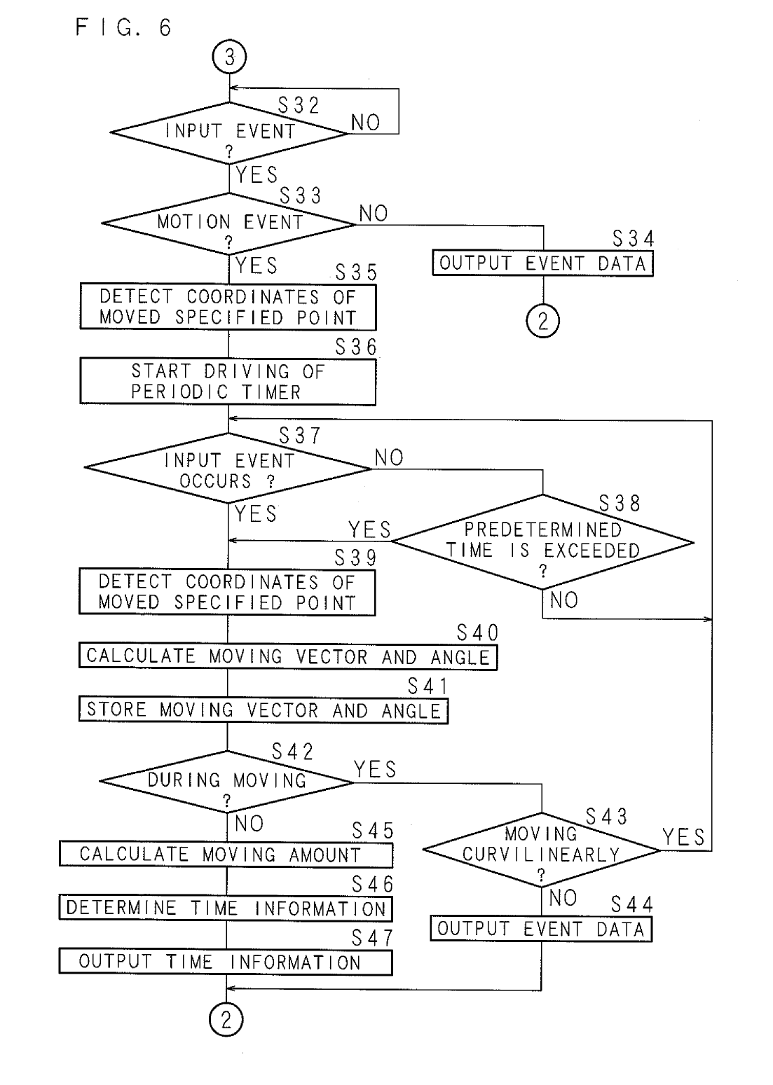

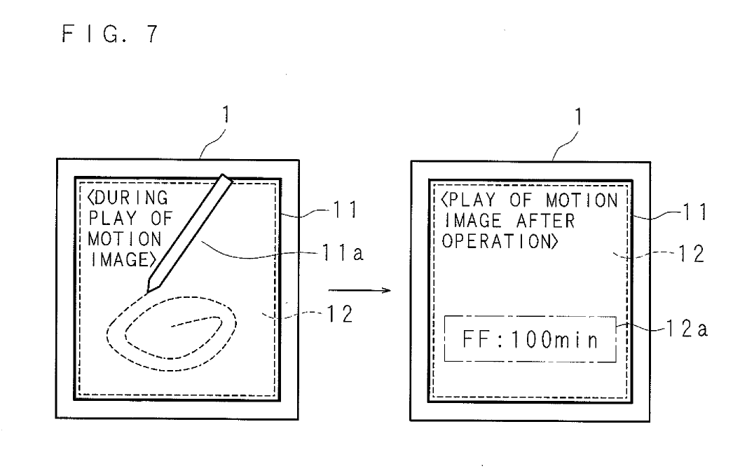

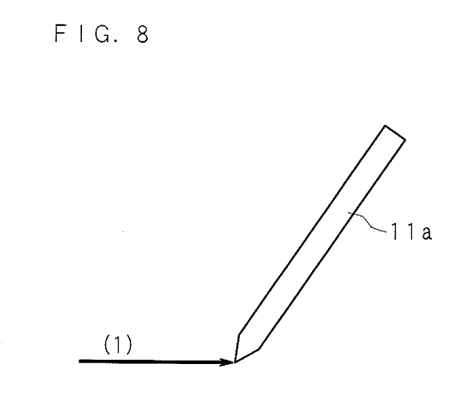

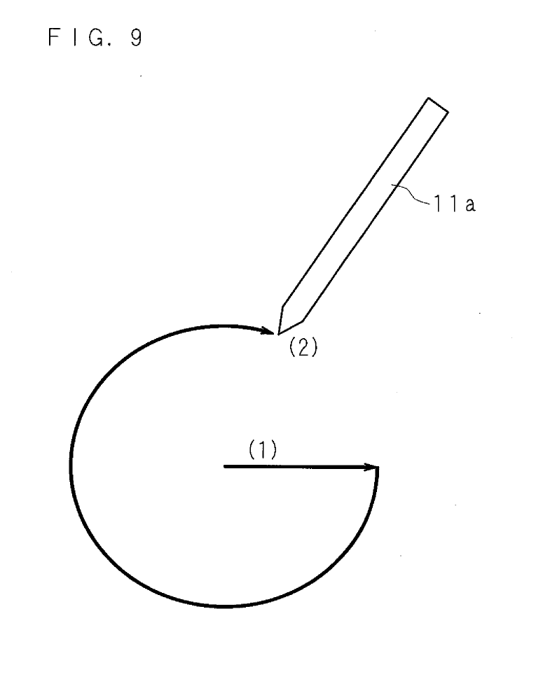

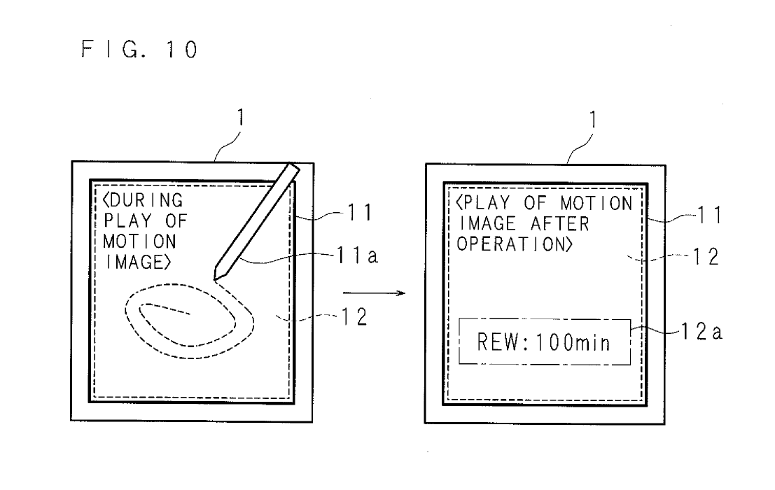

FIGS. 4 to 6 are flowcharts that show a procedure regarding the time information accepting method according to the present embodiment. FIG. 7 is an explanation view that shows a method of forward operation for a motion image. FIG. 8 is an explanation view that shows an operation method for determining a time scale. FIG. 9 is an explanation view that shows a method of input operation for time information. FIG. 10 is an explanation view that shows an operation method for rewinding the motion image. The time information accepting method is mainly implemented by the three processes, i.e., the process for detecting a reference point becoming the center of the circular motion, the process for determining the time scale by detecting the linear movement operation, and the process for determining the time information by detecting curvilinear movement operation of the circular motion following to the linear movement operation. The particular contents of these processes are explained below.

### <Reference Point Detecting Process>

The time operation processing unit 13 firstly performs the initializing process (step S11). Particularly, the time operation processing unit 13 initializes the hardware configuring the time information accepting apparatus 1, the several variables and the periodic timer 13e.

Then, the time operation processing unit 13 judges whether the specified point is detected on the predetermined plane surface due to the pointing device 11 or not, i.e., whether the input event representing the fact that the stylus pen 11a comes into contact with the touch panel and the coordinate value data representing the contact position are obtained or not (step S12). When judging that the specified point is not detected (step S12: NO), the time operation processing unit 13 performs the process at the step S12 again. When judging that the specified point is detected (step S12: YES), the time operation processing unit 13 drives the periodic timer 13e (step S13).

After the process at the step S13, the time operation processing unit 13 outputs the event data contained in the operation information that is outputted from the pointing device 11, toward the control unit 14 (step S14).

Then, the time operation processing unit 13 checks the operation condition of the pointing device 11, and judges whether the input event occurs or not (step S15). In short, the time operation processing unit 13 judges whether the event data is obtained or not.

When judging that the input event is occurred (step S15: YES), the time operation processing unit 13 judges whether the time clocked by the periodic timer 13e exceeds a predetermined time or not (step S17). When judging that the predetermined time is not exceeded (step S17: NO), the time operation processing unit 13 outputs the event data to the control unit 14 (step S18), and returns the procedure to the step S11.

When the input event does not occur (step S15: NO), the time operation processing unit 13 judges whether the time clocked by the periodic timer 13e exceeds a predetermined time or not (step S16). When judging that the predetermined time is not exceeded (step S16: NO), the time operation processing unit 13 returns the procedure to the step S15. When judging at the step S16 or S17 that the predetermined time is exceeded (step S16 or S17: YES), the time operation processing unit 13 treats the specified point recognized at the step S12 as the reference point and stores the coordinates of the reference point (step S19). As shown in FIG. 7, the reference point corresponds to a base point for the linear movement performed at the previous step for moving the specified point to orbit clockwise. In short, the reference point corresponds to the center for the circular motion of the specified point.

### <Time Scale Determining Process>

Then, the time operation processing unit 13 checks the operation condition of the pointing device 11, and judges whether the input event occurs or not (step S20). When judging that the input event does not occur (step S20: NO), the time operation processing unit 13 performs the process at the step S20 again. When judging that the input event occurs (step S20: YES), the time operation processing unit 13 judges whether the type of input event is the motion event or not (step S21). In other words, it judges whether the specified point moves on the touch panel or not.

When judging that it is not the motion event (step S21: NO), the time operation processing unit 13 outputs the obtained event data to the control unit 14 (step S22), and returns the procedure to the step S11.

When judging that it is the motion event (step S21: YES), the time operation processing unit 13 detects the coordinates of the moved specified point (step S23). Particularly, the time operation processing unit 13 obtains the coordinate value data contained in the operation information that is outputted from the pointing device 11.

The time operation processing unit 13 starts driving the periodic timer 13e (step S24). Then, the time operation processing unit 13 checks the operation condition of the pointing device 11 and judges whether the input event occurs or not (step S25).

When the input event does not occur (step S25: NO), the time operation processing unit 13 judges whether the time clocked by the periodic timer 13e exceeds a predetermined time or not (step S26). When judging that the predetermined time is not exceeded (step S26: NO), the time operation processing unit 13 returns the procedure to the step S25.

When judging at the step S25 that the input event occurs (step S25: YES) or judging at the step S26 that the predetermined time is exceeded (step S26: YES), the time operation processing unit 13 detects the coordinates of the moved specified point (step S27). Then, the time operation processing unit 13 judges whether the specified point is still moving or not (step S28). When judging that it is still moving (step S28: YES), the time operation processing unit 13 judges whether the specified point is moving linearly as shown in FIG. 8 or not (step S29). It should be noted that, if the linear moving direction is changed reversely from a predetermined direction while it is moving linearly in the predetermined direction, the specified point is judged to be under the linear movement. When judging that the specified point is moving linearly (step S29: YES), the time operation processing unit 13 returns the procedure to the step S25. When judging that the specified point is not moving linearly (step S29: NO), the time operation processing unit 13 outputs the event data obtained from the pointing device 11 to the control unit 14 (step S30), and returns the procedure to the step S11.

When judging at the step S28 that the specified point is not moving (step S28: NO), the time operation processing unit 13 determines the unit quantity of time corresponding to the moving amount of the specified point by calculating the moving amount of the specified point (step S31). The moving amount of the specified point contains a unit length of the linear distance on the predetermined plane surface, a unit angle of the specified point moving circularly, and the like.

The unit quantity of time is determined to be shorter, as the linear moving distance of the moved specified point from the reference point is longer. Vice versa, the unit quantity of time is determined to be longer, as the linear moving distance is shorter. Of course, the unit quantity of time may be alternatively determined to be longer as the linear moving distance is longer, and determined to be shorter as the linear moving distance is shorter.

### <Time Information Determining Process>

After the process at the step S31, the time operation processing unit 13 checks the operation condition of the pointing device 11, and judges whether the input event occurs or not (step S32). When judging that the input event does not occur (step S32: NO), it performs the process at the step S32 again. When judging that the input event occurs (step S32: YES), the time operation processing unit 13 judges whether the type of the input event is the motion event or not (step S33).

When judging that it is not the motion event (step S33: NO), the time operation processing unit 13 outputs the obtained event data to the control unit 14 (step S34), and returns the procedure to the step S11.

When judging that it is the motion event (step S33: YES), the time operation processing unit 13 detects the coordinates of the moved specified point (step S35). Particularly, the time operation processing unit 13 obtains the coordinate value data contained in the operation information that is outputted from the pointing device 11.

The time operation processing unit 13 starts driving the periodic timer 13e (step S36). Then, the time operation processing unit 13 checks the operation condition of the pointing device 11 and judges whether the input event occurs or not (step S37).

When the input event does not occur (step S37: NO), the time operation processing unit 13 judges whether the time clocked by the periodic timer 13e exceeds a predetermined time or not (step S38). When judging that the predetermined time is not exceeded (step S38: NO), the time operation processing unit 13 returns the procedure to the step S37.

When judging at the step S37 that the input event occurs (step S37: YES) or judging at the step S38 that the predetermined time is exceeded (step S38: YES), the time operation processing unit 13 detects the coordinates of the moved specified point (step S39). Then, the time operation processing unit 13 calculates the moving vector and angle of the specified point having moved circularly (step S40), and stores the calculated moving vector and angle (step S41).

The time operation processing unit 13 judges whether the specified point is still moving or not (step S42). When judging that it is still moving (step S42: YES), the time operation processing unit 13 judges whether the specified point is moving curvilinearly as shown in FIGS. 7 and 9, or not (step S43). At that time, it judges whether the specified point is under the circular motion, i.e., the specified point is moving on an arcuate path, or not. It should be noted that, if the moving direction is changed to anticlockwise while it is moving clockwise on the arcuate path, the specified point is judged to move curvilinearly. When judging that the specified point is moving curvilinearly (step S43: YES), the time operation processing unit 13 returns the procedure to the step S37. When judging that the specified point is not moving curvilinearly (step S43: NO), the time operation processing unit 13 outputs the event data obtained from the pointing device 11 to the control unit 14 (step S44), and returns the procedure to the step S11.

When judging at the step S42 that the specified point is not moving (step S42: NO), the time operation processing unit 13 calculates the moving amount regarding the curvilinear movement operation (step S45), and determines the time information based on the calculated moving amount and the unit quantity of time determined at the step S31 (step S46). For example, the time operation processing unit 13 multiplies the unit quantity of time determined at the step S31 and the moving amount calculated at the step S45. For example, when the specified point moves clockwise with 360 degrees under the case that the time scale has been determined in which the clockwise angle 60 degree is set to correspond to the length of 10 minutes, the time information representing 60 minutes is outputted. In addition, when the specified point moves anticlockwise with 360 degrees as shown in FIG. 10, the time information representing minus 60 minutes is outputted. Then, the time operation processing unit 13 outputs the determined time information to the control unit 14 (step S47), and returns the procedure to the step S11.

The control unit 14 obtains the time information outputted from the time operation processing unit 13, and forwards or rewinds the played motion image in accordance with the obtained time information. For example, when the specified point circularly moves clockwise with 360 degrees under the case described above, the motion image is forwarded by 60 minutes. For example, when the specified point circularly moves anticlockwise with 360 degrees under the case described above, the motion image is rewound by 60 minutes.

The above description mainly explains that the specified point is not in reverse motion for the linear movement operation and curvilinear movement operation. However, the specified point may be in reverse motion under the movement operation of the specified point.

The above description explains an example in which the moving amount of the specified point regarding the curvilinear movement operation is calculated after the unit quantity is determined. However, it may be configured that the unit quantity is determined after the moving amount of the specified point regarding the curvilinear movement operation is calculated. In addition, the above description explains an example in which the unit quantity of time is determined in accordance with the moving amount of the specified point regarding the linear movement operation. However, it may be configured that the unit quantity of time is determined in accordance with the moving speed of the specified point regarding the linear movement operation. Furthermore, it may be configured that the unit quantity of time is determined in accordance with both the moving amount and moving speed of the specified point.

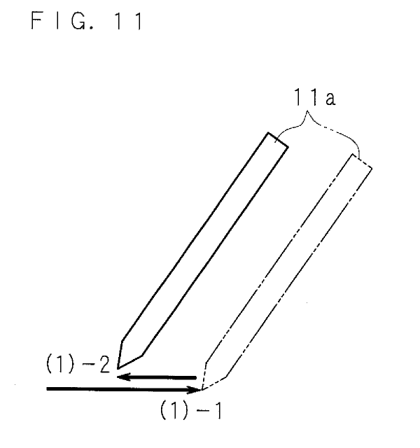

FIG. 11 is an explanation view that shows a reciprocating linear movement operation performed when the time scale is inputted. For example, when the reverse linear movement occurs with the reverse moving direction on the specified point being linearly moved, the distance between the start point and the end point in the linear movement is calculated at the step S31, and the unit quantity of time is increased or decreased in accordance with the calculated distance.

It will be explained below about the case that the unit quantity of time becomes shorter as the distance of the linear movement operation is longer. In the case, the unit quantity of time becomes shorter to be one hour, one minute or one second, by keeping the linear movement operation. When the specified point is linearly moved to the position shown by the (1)-1 with the unit quantity of time being 1 second and then it is reversely moved to the reference point side, the unit quantity of time becomes reversely longer to be one second, one minute, or one hour. As described above, the user can adjust and determine the unit quantity of time by reciprocating the specified point.

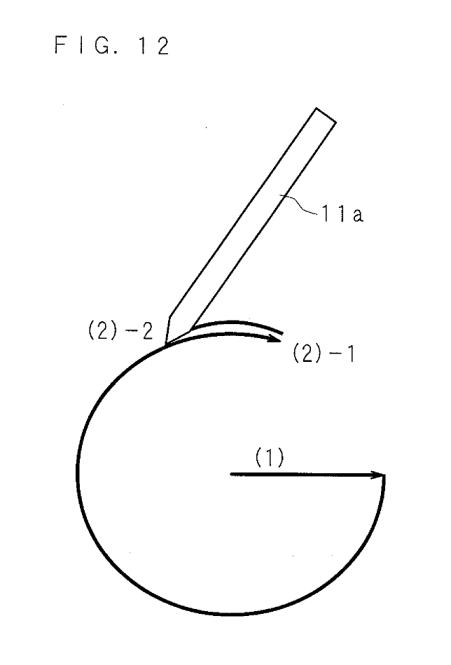

FIG. 12 is an explanation view that shows a reciprocating curvilinear movement operation performed when the time information is inputted. Similarly to the linear movement operation, the user can adequately increase or decrease the input time by applying the reverse circular motion on the specified point moving circularly.

When the specified point is circularly moved clockwise, the time of accepted object becomes longer to be 10 minutes, 20 minutes or 30 minutes. When the specified point is circularly moved to the position shown by the (2)-1 with the unit quantity of time being 50 minutes and then it is reversely moved, the unit quantity of time becomes reversely shorter to be 50 minutes, 40 minutes, or 30 minutes.

The time information accepting apparatus 1 and the time information accepting method described above can accept the time information with the intuitive and simple operation, without the slide bar. Particularly, the user can utilize the length of linear movement operation in order to input the time scale and can utilize the moving amount of the curvilinear movement operation for the circular motion following to the linear movement in order to input the time information.

The present embodiment is configured to calculate the moving amount of the specified point regarding the circular motion after determining the time scale. However, it may be configured to calculate the moving amount of the specified point regarding the circular motion before determining the time scale.

### Alternative Embodiment 1

The time information accepting apparatus 1 according to the alternative embodiment 1 is configured to calculate the moving speed of the linear movement operation for the specified point and then to calculate the time scale, which is different from the previous embodiment. Thus, it will be mainly explained below about the difference described above.

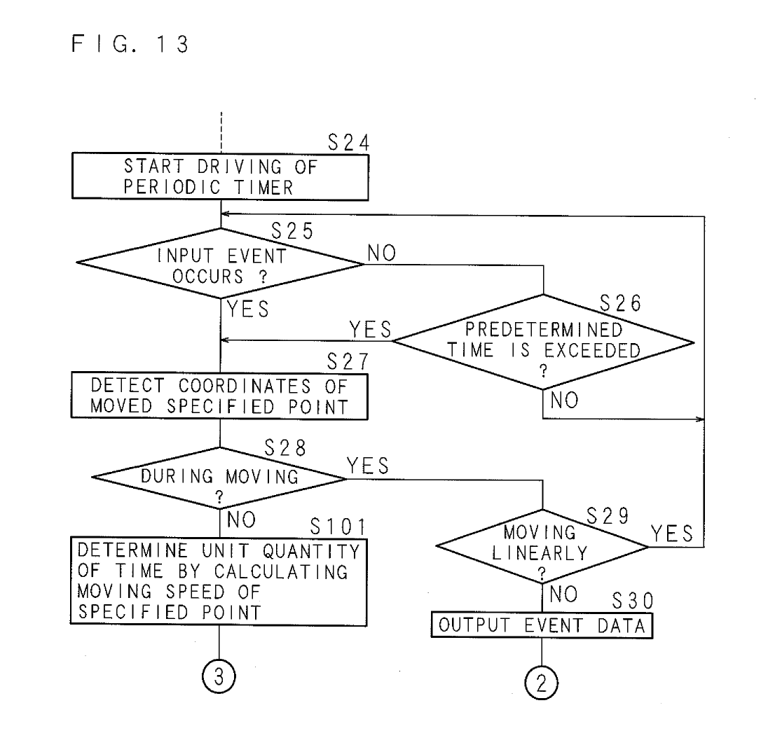

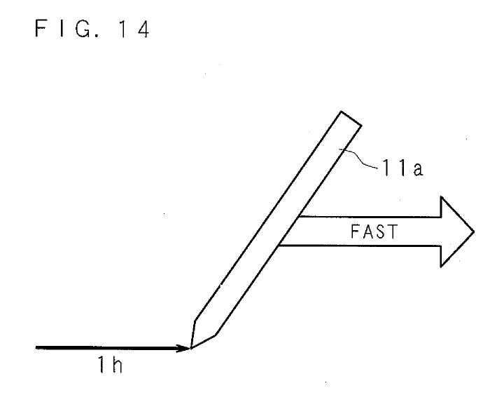

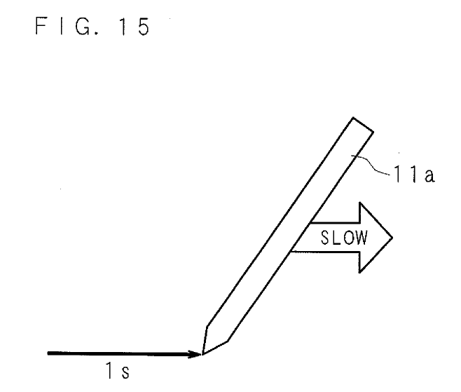

FIG. 13 is a flowchart that shows a procedure regarding the time information accepting method according to the alternative embodiment 1. FIGS. 14 and 15 are explanation views that show an operation for setting the time scale.

The time operation processing unit 13 performs the processes at the steps S11 to S30, similarly to the previous embodiment. When judging at the step S28 that the specified point is not moving (step S28: NO), the time operation processing unit 13 determines the unit quantity of time corresponding to the moving amount of the specified point by calculating the moving speed of the specified point (step S101).

The unit quantity of time is determined to become longer when the moving speed of the specified point moving from the reference point as shown in FIG. 14 is faster. Vice versa, the unit quantity of time is determined to become shorter when the moving speed of the specified point moving from the reference point as shown in FIG. 15 is slower. Of course, it may be alternatively configured that the unit quantity of time is determined to become shorter when the moving speed of the specified point is faster, and to become longer when the moving speed of the specified point is slower.

After the process at the step S101, the time operation processing unit 13 performs the processes following to the step S32, similarly to the previous embodiment.

With the time information accepting apparatus 1 and the time information accepting method according to the alternative embodiment 1, the user can utilize the speed of linear movement operation in order to input the time scale and can utilize the moving amount of the curvilinear movement operation for the circular motion following to the linear movement in order to input the time information.

### Alternative Embodiment 2

The time information accepting apparatus 1 according to the alternative embodiment 2 is configured to determine the time scale based on the resolution of the display unit 12, which is different from the previous embodiment. Thus, it will be mainly explained below about the difference described above.

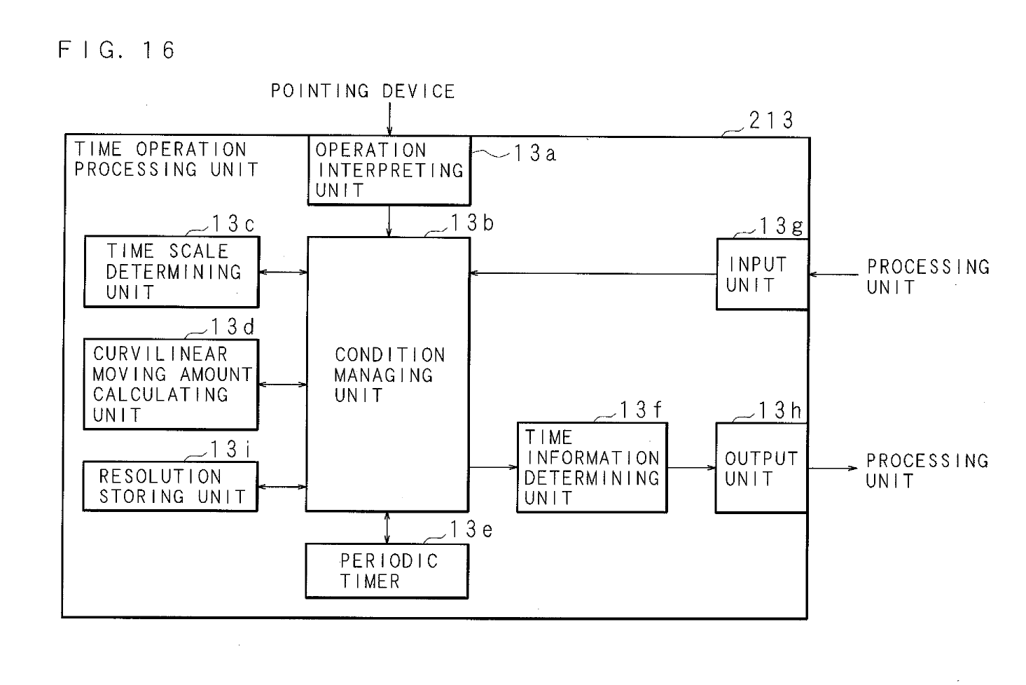

FIG. 16 is a block diagram that shows an example configuration of a time operation processing unit 213 according to the alternative embodiment 2. The time operation processing unit 213 according to the alternative embodiment 2 includes a resolution storing unit 13i that stores resolution data representing the resolution of the display unit 12. For example, the resolution storing unit 13i is a non-volatile memory, such as a ROM and a flash memory. It outputs the resolution to the condition managing unit 13b, in accordance with the control instruction from the condition managing unit 13b. The condition managing unit 13b outputs not only the operation information but also the resolution data obtained from the resolution storing unit 13i toward the time scale determining unit 13c, to make it determine the time scale. For example, the time scale determining unit 13c then determines the length of time corresponding to one pixel on the display unit 12.

The time information accepting apparatus according to the alternative embodiment 2 generates the effects similar to those of previous embodiment.

The consideration about the resolution of the display unit 12 can lead the applicability for display a scale on the straight line or the curve line after the interaction, or for utilizing the time display process while some process is still being performed.

### Alternative Embodiment 3

The time information accepting apparatus according to the alternative embodiment 3 is configured to determine the time scale based on the actual size of the display unit 12, which is different from the previous embodiment. Thus, it will be mainly explained below about the difference described above.

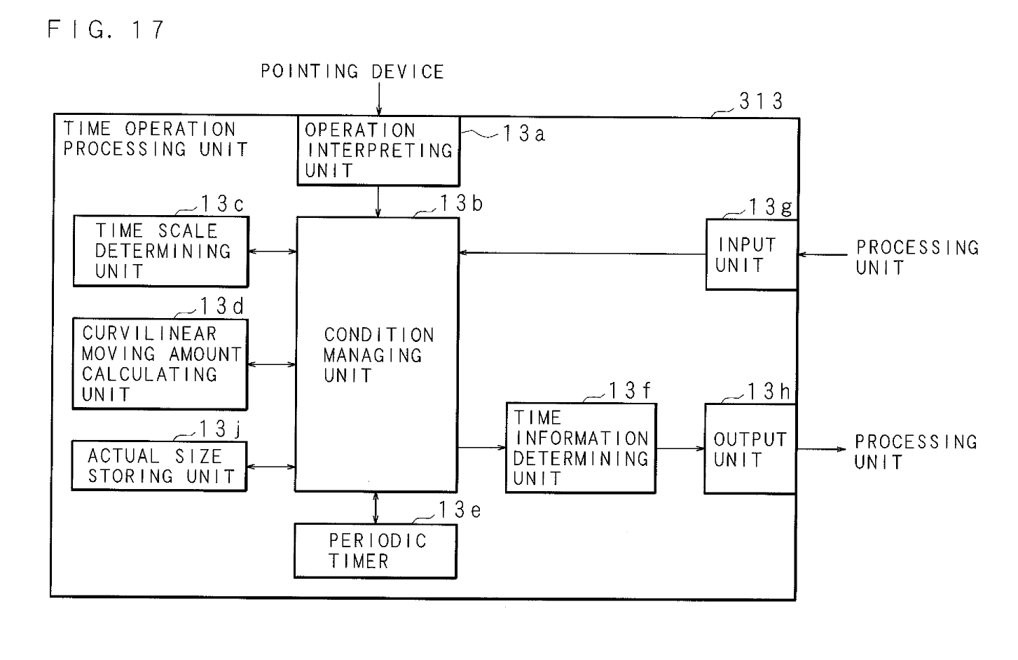

FIG. 17 is a block diagram that shows an example configuration of a time operation processing unit 313 according to the alternative embodiment 3. The time operation processing unit 313 according to the alternative embodiment 3 includes an actual size storing unit 13j that stores the actual size data representing the actual size of the display unit 12. For example, the actual size storing unit 13j is a non-volatile memory, such as a ROM and a flash memory. It outputs the actual size to the condition managing unit 13b, in accordance with the control instruction from the condition managing unit 13b. The condition managing unit 13b outputs not only the operation information but also the actual size data obtained from the actual size storing unit 13j to the time scale determining unit 13c, to make it determine the time scale. For example, the time scale determining unit 13c then determines the unit length for the actual size of the display unit 12, such as the length of time corresponding to 1 cm.

The time information accepting apparatus according to the alternative embodiment 3 generates the effects similar to those of previous embodiment.

The actual size of the display unit 12 can be utilized as the information for identifying the movement of coordinate point on the display unit 12. For example, the distance limitation is determined for projecting a straight line, if the region of display unit 12 is determined under the limitation for the actual size. Thus, it is expected to simplify the processes, merely by determining previously the distance in order to reach it and perform the judgment about the actual size. If the region is too small, it is expected to feedback something to the display process. For example, no scale by the unit of second may be applied.

### Alternative Embodiment 4

The time information accepting apparatus according to the alternative embodiment 4 is configured to display the time scale and the time information during the input operation, which is different from the previous embodiment. Thus, it will be mainly explained below about the difference described above.

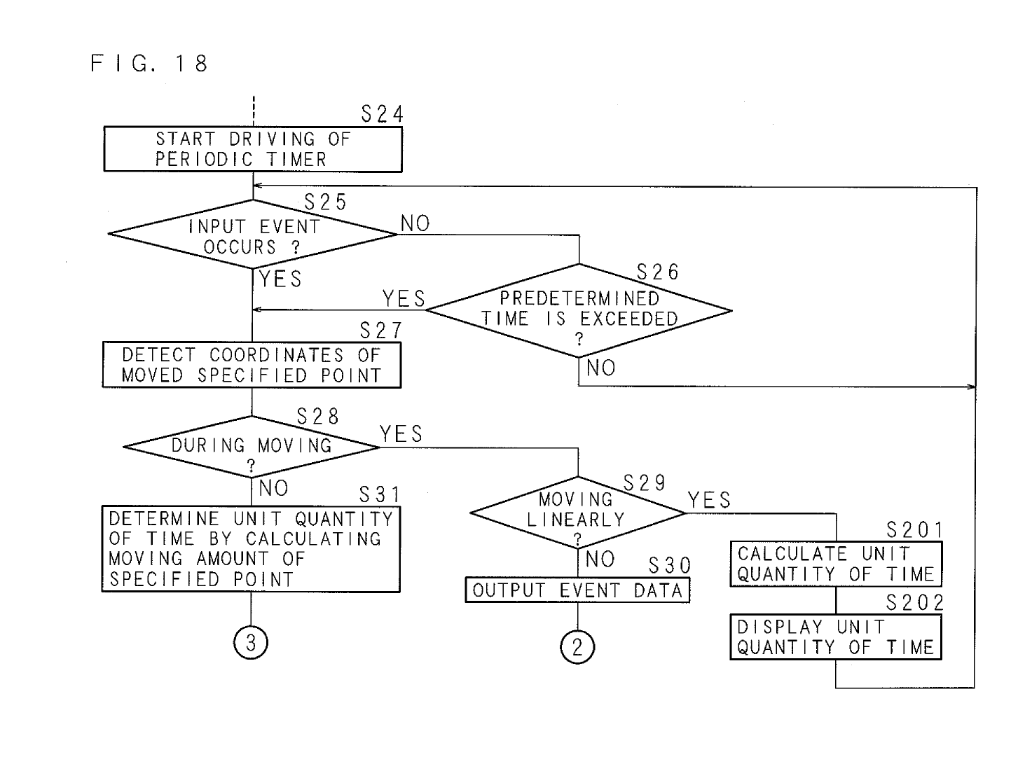

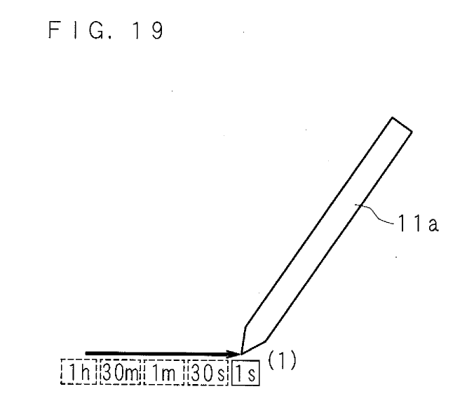

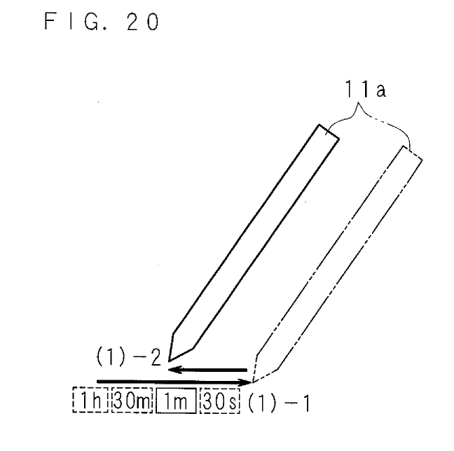

FIG. 18 is a flowchart that shows a procedure regarding the time information accepting method according to the alternative embodiment 4, especially a procedure for displaying the time scale. FIGS. 19 and 20 are explanation views that show a method for displaying the time scale. The time operation processing unit 13 performs the processes at the steps S11 to S29, similarly to the previous embodiment. When judging at the step S29 that the specified point is moving linearly (step S29: YES), the time operation processing unit 13 calculates the moving amount of the specified point, to calculate the unit quantity of time corresponding to the moving amount of the specified point at that time (step S201). Then, the time operation processing unit 13 makes the display unit 12 display the calculated unit quantity of time, as shown in FIGS. 19 and 20 (step S202), and returns the procedure to the step S25.

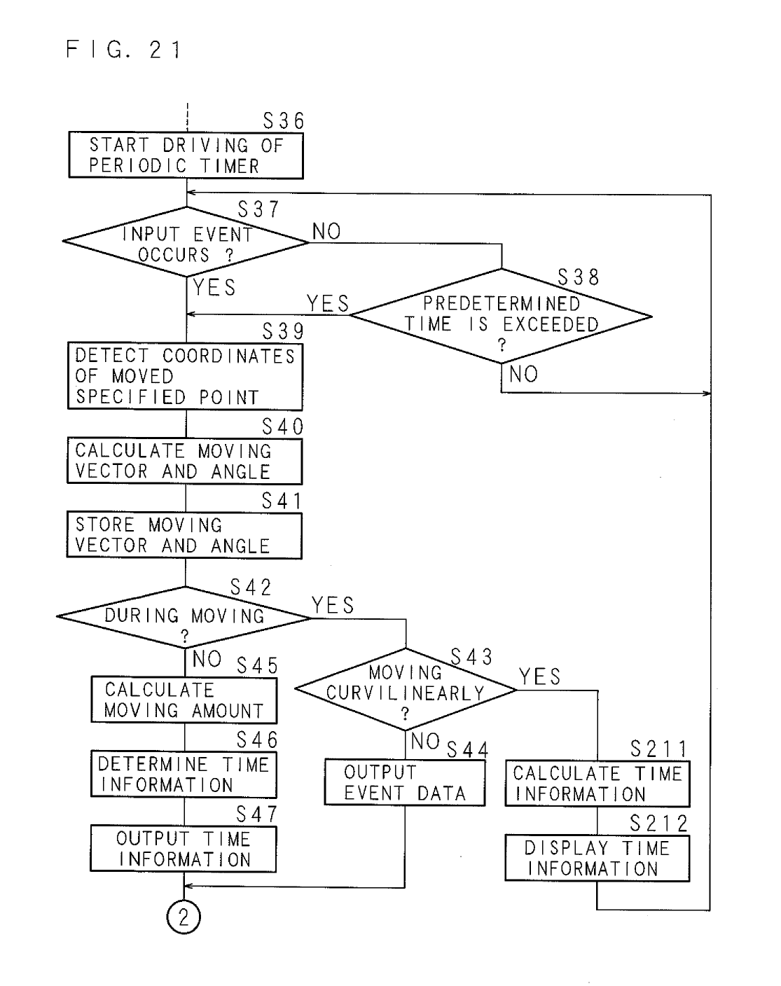

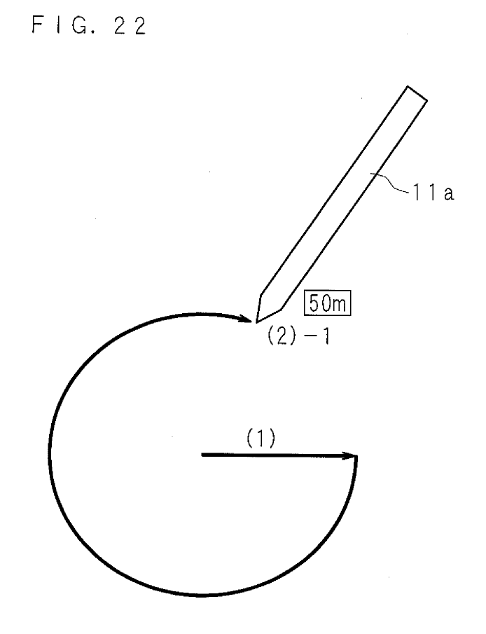

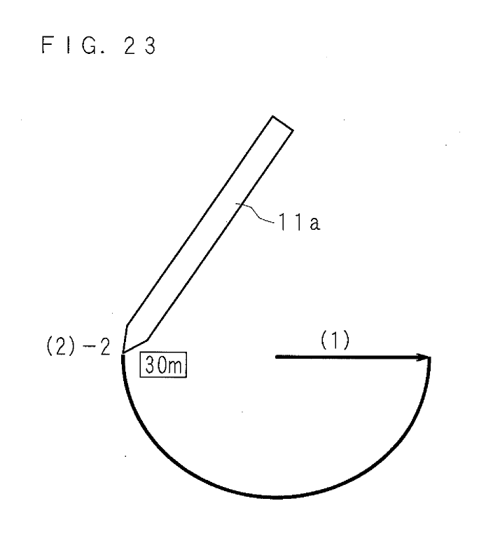

FIG. 21 is a flowchart that shows a procedure regarding the time information accepting method according to the alternative embodiment 4, especially a procedure for displaying the time information. FIGS. 22 and 23 are explanation views that show a method for displaying the time information. The time operation processing unit 13 performs the processes at the steps S30 to S43, similarly to the previous embodiment. When judging at the step S43 that the specified point is moving curvilinearly (step S43: YES), the time operation processing unit 13 calculates the moving amount regarding the curvilinear movement operation, and calculates the present time information based on the calculated moving amount and the unit quantity of time determined at the step S31 (step S211). Then, the time operation processing unit 13 makes the display unit 12 display the calculated length of time, as shown in FIGS. 22 and 23 (step S212), and returns the procedure to the step S37.

The other processes following to the step S44 are performed similarly to the previous embodiment, and thus the detail explanation is omitted.

With the time information accepting apparatus 1 and the time information accepting method according to the embodiment 4, the user can performs the linear movement operation and the curvilinear movement operation while confirming the time scale and the time information during the input operation, to input the time information.

### Alternative Embodiment 5

The time information accepting apparatus 1 according to the alternative embodiment 5 is configured to specify the play start position by the direction of linear movement operation, which is different from the previous embodiment. Thus, it will be mainly explained below about the difference described above.

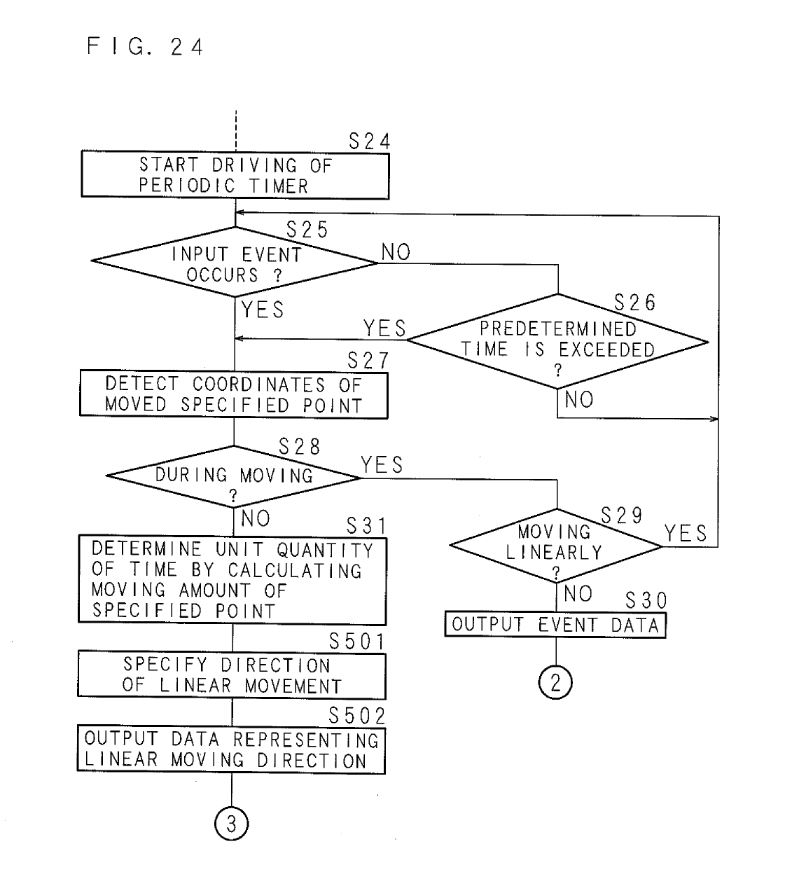

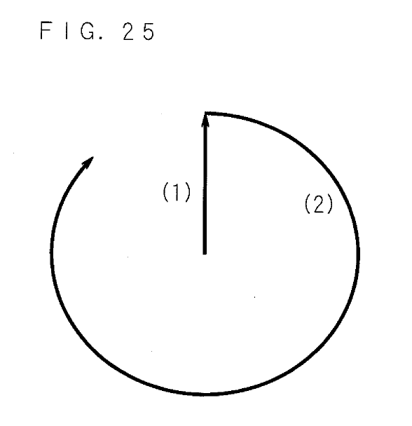

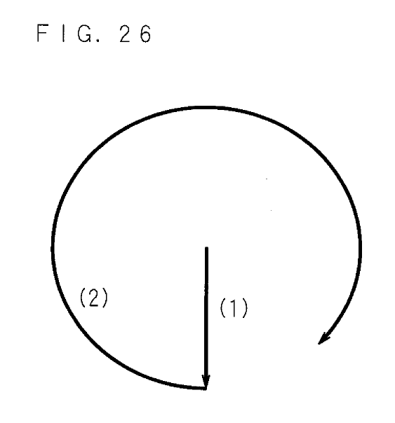

FIG. 24 is a flowchart that shows a procedure regarding the time information accepting method according to the alternative embodiment 5. FIGS. 25 and 26 are explanation views that show an operation for specifying a play start position. The time operation processing unit 13 performs the processes at the steps S11 to S31, similarly to the previous embodiment. After the process at the step S31, the time operation processing unit 13 specifies the direction of linear movement operation, based on the obtained operation information (step S501). Then, the time operation processing unit 13 outputs the data representing the specified direction of linear movement operation to the control unit 14 (step S502). For example, when the specified point moves upwardly from the reference point as shown in FIG. 25, the time operation processing unit 13 outputs data, representing that the specified point is moving upwardly, to the control unit 14. For example, when the specified point moves downwardly from the reference point as shown in FIG. 26, the time operation processing unit 13 outputs data, representing that the specified point is moving downwardly, to the control unit 14. After the process at the step S502, the control unit 14 performs the processes following to the step S32, similarly to the previous embodiment.

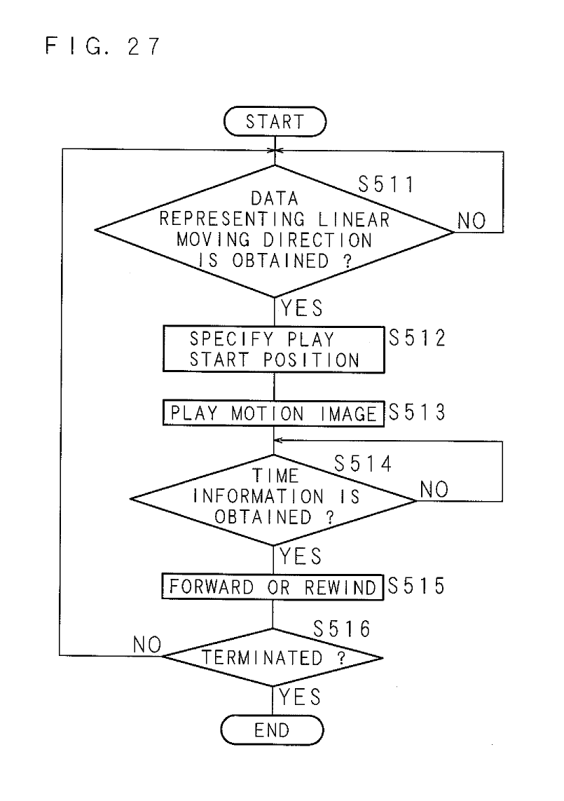

FIG. 27 is a flowchart that shows a procedure for playing the motion image data. The control unit 14 judges whether the data representing the linear moving direction of the specified point is obtained from the time operation processing unit 13 or not (step S511). When judging that the data representing the linear moving direction is not obtained (step S511: NO), the control unit 14 performs the process at the step S511 again. When judging that the data representing the linear moving direction is obtained (step S511: YES), the control unit 14 specifies the play start position based on the linear moving direction of the specified point (step S512). For example, when the linear moving direction is the upward direction, the head portion of the motion image is specified. For example, when the linear moving direction is the downward direction, the middle portion for the play time of the motion image is specified. For example, in the case that whole play time of the motion image is one hour, the middle portion is a play portion which is 30 minutes later than the head portion.

After that, the control unit 14 starts playing the motion image from the play start position (step S513). Then, the control unit 14 judges whether the time information is obtained from the time operation processing unit 13 or not (step S514). When judging that the time information is not obtained (step S514: NO), the control unit 14 performs the process at the step S514 again.

When judging that the time information is obtained (step S514: YES), the control unit 14 performs the forward process or the rewind process with respect to the play start position specified at the step S512 (step S515). For example, when the specified point is moved as shown in FIG. 25, the motion image is played from the head portion and is forwarded from the head portion. For example, when the specified point is moved as shown in FIG. 26, the motion image is played from the middle portion described above and is forwarded from the middle portion.

After the process at the step S515, the time operation processing unit 13 judges whether the play process for the motion image should be terminated or not, in accordance with the operation information inputted from the pointing device 11 through the time operation processing unit 13 (step S516). When judging that the play process for the motion image should not be terminated (step S516: NO), the control unit 14 returns the procedure to the step S511. When judging that the play process for the motion image should be terminated (step S 511: YES), the control unit 14 ends the procedure.

In the flowchart described above, it explains about only the play start process for the motion image data. Of course, but it is configured, when the control unit 14 obtains other input events, to perform the processes corresponding to the obtained input events.

The time information accepting apparatus 1 according to the alternative embodiment 5 can utilize the direction of the linear movement operation provided for determining the time scale in order to intuitively specify the play start position, and can utilize the curvilinear movement operation following to the linear movement operation in order to forward or rewind the played motion image.

### Alternative Embodiment 6

The time information accepting apparatus 601 according to the alternative embodiment 6 is configured with a display unit 612 and a pointing device 611 that are aligned together, which is different from the previous embodiment. Thus, it will be mainly explained below about the difference described above.

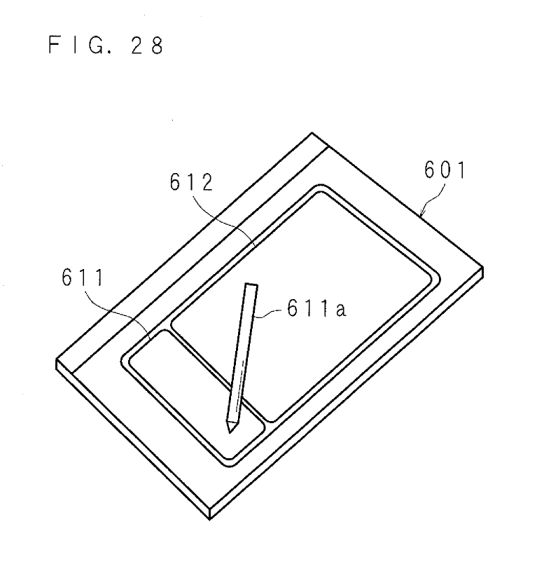

FIG. 28 is a perspective view that shows an example configuration of the time information accepting apparatus 601 according to the alternative embodiment 6. Although the previous embodiment is explained with the touch panel that includes the pointing device 611 arranged on the whole surface of the display unit 612, the time information accepting apparatus 601 according to the alternative embodiment 6 includes the display unit 612 and the pointing device 611 that are aligned but not overlapped to each other.

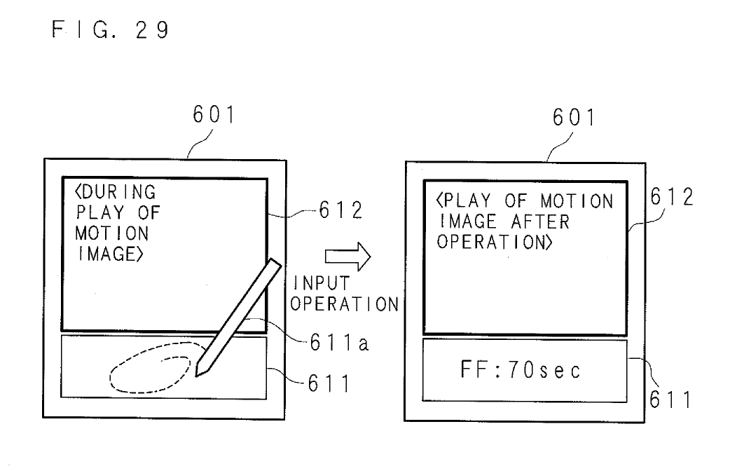

FIG. 29 is an explanation view that shows an operation for inputting the time information. With the time information accepting apparatus 601 described above, the play operation for the motion image can be done by operating the pointing device 611 arranged at a position different from the position of the display unit 612 on which the motion image is displayed. Therefore, it is possible to prevent the operation for the pointing device 611 from interfering the viewing of motion image

### Alternative Embodiment 7

The time information accepting apparatus 701 according to the alternative embodiment 7 is configured with plural aligned display units and the pointing device 711 is arranged on the front surface of the first display unit, which is different from the previous embodiment. Thus, it will be mainly explained below about the difference described above.

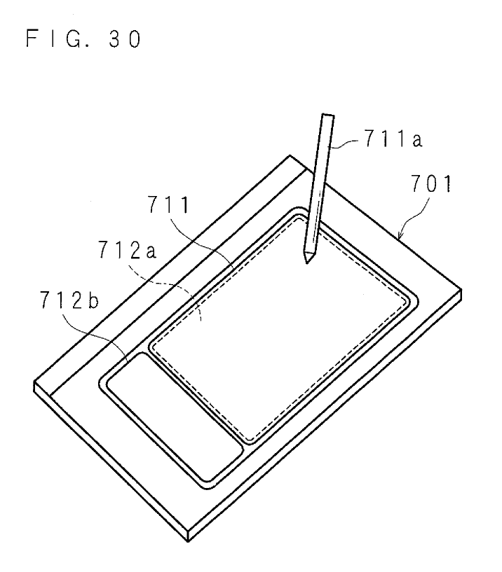

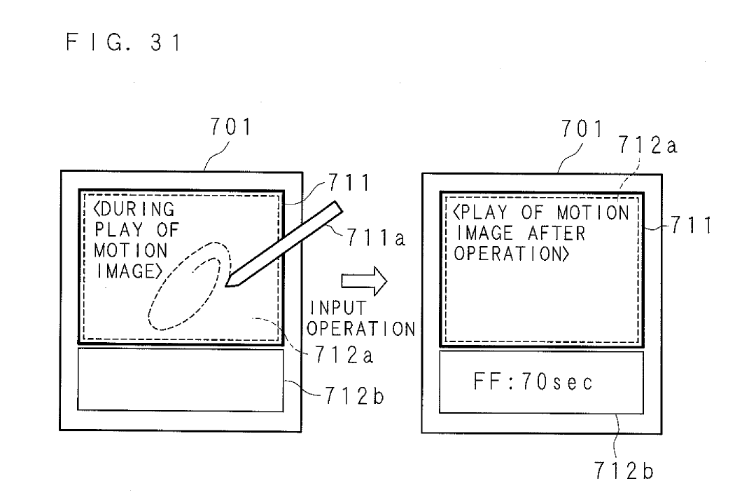

FIG. 30 is a perspective view that shows an example configuration of the time information accepting apparatus 701 according to the alternative embodiment 7. FIG. 31 is an explanation view that shows an operation for inputting the time information. The time information accepting apparatus 701 according to the alternative embodiment 7 includes a first display unit 712a and a second display unit 712b which are aligned together. The pointing device 711 is arranged on the front surface of the first display unit 712a. The control unit 14 displays the motion image on the first display unit 712a and displays the GUI on the second display unit 712b, while the GUI relates to the operations, such as the play operation for the motion image.

The time information accepting apparatus 701 according to the alternative embodiment 7 can prevent the display of play operation from interfering the viewing of motion image, because the result of play operation is displayed on the second display unit 712b that is arranged on a position different from a position of the first display unit 712a on which the motion image is displayed.

### Alternative Embodiment 8

The time information accepting apparatus 801 according to the alternative embodiment 8 is configured as a remote operation apparatus for the present invention, which is different from the previous embodiment. Thus, it will be mainly explained below about the difference described above.

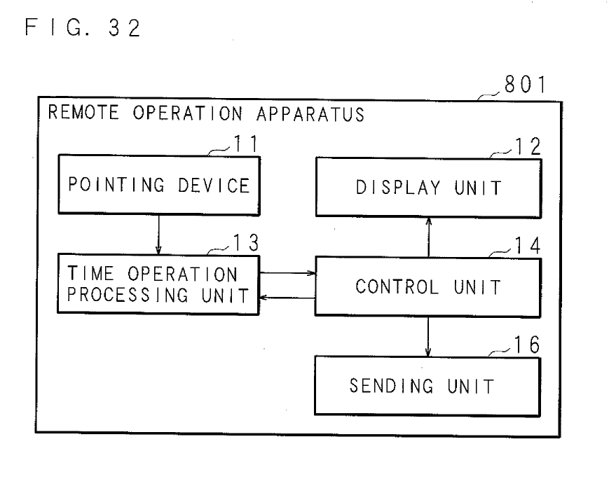

FIG. 32 is a block diagram that shows an example configuration of the remote operation apparatus according to the alternative embodiment 8. The remote operation apparatus according to the alternative embodiment 8 includes the pointing device 11, the display unit 12, the time operation processing unit 13, and the control unit 14, similarly to the previous embodiment. In addition, the time operation processing unit 13 includes a sending unit 16 that sends the remote operation signal containing the determined time information and other operation information.

Similarly to the previous embodiment, the time information accepting apparatus 801 according to the alternative embodiment 8 can utilize the intuitive and simple operation without the slide bar, to accept the time information and send the remote operation signal containing the accepted time information toward an external apparatus.

### Alternative Embodiment 9

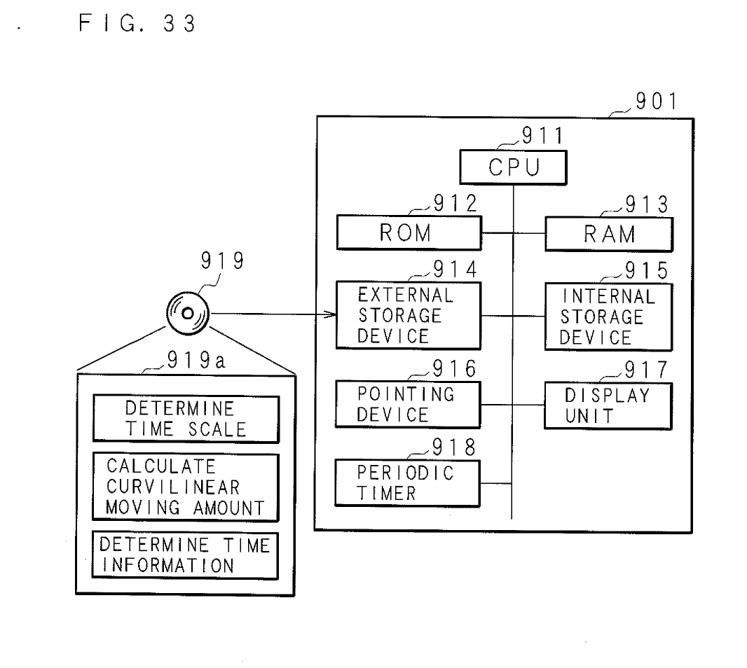

FIG. 33 is a block diagram that shows an example configuration of the time information accepting apparatus 1 according to the alternative embodiment 9. The time information accepting apparatus 1 according to the alternative embodiment 9 is implemented by making a computer 901 execute a computer program 919a according to the present invention.

The computer 901 includes a CPU (Central Processing Unit) that controls the whole of the apparatus. The CPU 911 is connected to a ROM (Read Only Memory) 912, a RAM (Random Access Memory) 913 that stores temporal information generated by the calculation, an external storage device 914 that reads computer program 919a from a recording medium 919 recording the computer program 919a according to the present embodiment of the present invention, such as a CD-ROM, an internal storage device 915 which records the computer program 919a read by the external storage device 914, such as a hard disk, a pointing device 916, a display unit 917, and a periodic timer 918. The CPU 911 reads out the computer program 919a from the internal storage device 915 onto the RAM 913 and then performs several calculation processes, to implement the motion image processing method according to the present invention. The procedure of the CPU 911 is shown by FIGS. 4 to 6, and the processes at the steps S11 to S47 are performed. The present procedure is similar to the procedure performed by each component configuring the time information accepting apparatus 1 according to the previous embodiment, and thus the detailed explanation is omitted. Of course, but it may be configured to perform the procedures according to the alternative embodiments 1 to 5.

Although the CD-ROM is described as an example of the recording medium, it is possible to utilize a tape type one, such as a magnetic tape and a cassette tape, a disk type one, such as a magnetic disk containing flexible disk/hard disk/and the like and an optical disk containing CD-ROM/MO/MD/DVD/CD-ROM/and the like, a card type one, such as an IC card (including a memory card)/optical card, a semiconductor memory, such as a mask ROM/EPROM/EEPROM/flash ROM, or the like.

The computer 901 and the computer program 919a according to the alternative embodiment 9 can make the computer 901 work as the time information accepting apparatus 1 according to the previous embodiment, can implement the motion image processing method according to the previous embodiment, and can generate the effects similar to those of the previous embodiment and alternative embodiments 1 to 6.

It should be noted, of course, that the computer program 919a according to the alternative embodiment 9 is not limited to the program recorded by the recording medium 919. It may be downloaded and stored through a wired or wireless communication network, to be executed.

It should be understood that the embodiments described above are only illustrative of the present invention and that various modifications may be made thereto without departing from the scope of the invention as defined in the claims. In other words, all changes that fall within metes and bounds of the claims or equivalence of such metes and bounds thereof are therefore intended to be embraced by the claims.

1-26. (canceled)

27. A time information accepting apparatus that accepts time information by detecting a movement operation of a coordinate point in a predetermined coordinate system, comprising:
a determining section that determines a unit quantity of time corresponding to a moving amount of a coordinate point in the predetermined coordinate system, by calculating a moving amount and/or moving speed of a coordinate point due to a first operation;
a calculating section that calculates a moving amount of a coordinate point due to a second operation; and
a time information determining section that determines time information based on the moving amount calculated by the calculating section and the unit quantity determined by the determining section.

28. The time information accepting apparatus according to claim 27,
wherein the predetermined coordinate system is a plane coordinate system.

29. The time information accepting apparatus according to claim 27,
wherein the coordinate point is specified by an input device.

30. The time information accepting apparatus according to claim 27,
wherein the first operation and the second operation are a series of movement operations of the coordinate point in the predetermined coordinate system.

31. The time information accepting apparatus according to claim 27,
wherein the first operation is a linear type movement operation of the coordinate point in the predetermined coordinate system.

32. The time information accepting apparatus according to claim 27,
wherein the second operation is a curvilinear type movement operation of the coordinate point in the predetermined coordinate system.

33. The time information accepting apparatus according to claim 32,
wherein the second operation is a movement operation in a circular or arcuate manner of the coordinate point in the predetermined coordinate system.

34. The time information accepting apparatus according to claim 33,
wherein the moving amount of the coordinate point due to the second operation includes an amount representing an angle of a start point and an end point for a moved coordinate point with respect to a center of a circle or an arc.

35. The time information accepting apparatus according to claim 33,
wherein the moving amount of the coordinate point due to the second operation includes an amount representing an orbiting frequency of the coordinate point.

36. The time information accepting apparatus according to claim 33,
wherein the moving amount of the coordinate point due to the second operation is increased or decreased in accordance with a moving direction of the coordinate point due to the second operation.

37. The time information accepting apparatus according to claim 33,
wherein the calculating section stores a moving vector of the coordinate point moved by the second operation or an angle of a start point and an end point for a moved coordinate point with respect to a center of a circle or an arc successively, and to calculate the moving amount based on stored plural moving vectors or angles.

38. The time information accepting apparatus according to claim 27,
wherein the calculating section calculates the moving amount of the coordinate point due to the second operation after the unit quantity is determined.

39. The time information accepting apparatus according to claim 27,
wherein the calculating section calculates the moving amount of the coordinate point due to the second operation before the unit quantity is determined.

40. The time information accepting apparatus according to claim 27,
wherein the calculating section stores a coordinate point being moved by the second operation successively, and to calculate the moving amount based on stored plural coordinate points.

41. The time information accepting apparatus according to claim 27,
wherein the moving amount of the coordinate point due to the first operation in the predetermined coordinate system is a distance between a start point and an end point of the moved coordinate point.

42. The time information accepting apparatus according to claim 27, further comprising:
a displaying section that has a display surface corresponding to the predetermined coordinate system; and
a resolution storing section stores a resolution of the displaying section,
wherein the determining section determines the unit quantity based on the moving amount or the moving speed of the coordinate point due to the first operation and on the resolution of the displaying section.

43. The time information accepting apparatus according to claim 27, further comprising:
a displaying section that has a display surface corresponding to the predetermined coordinate system; and
a actual size storing section that stores information regarding an actual size of the display surface of the displaying section,
wherein the determining section determines the unit quantity based on the moving amount or the moving speed of the coordinate point due to the first operation and on the information regarding the actual size of the display surface.

44. The time information accepting apparatus according to claim 27,
wherein the determining section determines the unit quantity being longer as the moving amount or the moving speed of the coordinate point due to the first operation is larger.

45. The time information accepting apparatus according to claim 27,
wherein the determining section determines the unit quantity being shorter as the moving amount or the moving speed of the coordinate point due to the first operation is larger.

46. The time information accepting apparatus according to claim 27, further comprising:
a length/time displaying section that displays a length of the unit quantity determined by the determining section or time regarding the time information determined by the time information determining section.

47. The time information accepting apparatus according to claim 27,
wherein the unit quantity of time corresponding to the moving amount of the coordinate point in the predetermined coordinate system is calculated successively while the coordinate point is moved by the first operation in the predetermined coordinate system, and the calculated unit quantity is displayed.

48. The time information accepting apparatus according to claim 27,
wherein time information is calculated successively based on the moving amount and the unit quantity of the coordinate point while the coordinate point is moved by the second operation in the predetermined coordinate system, and the calculated time information is displayed.

49. The time information accepting apparatus according to claim 27,
wherein time information for specifying a rewind position, a forward position and a play position with respect to a motion image play is accepted.

50. A time information accepting method that accepts time information by detecting a movement operation of a coordinate point in a predetermined coordinate system, comprising:
a determining step of determining a unit quantity of time corresponding to a moving amount of a coordinate point in the predetermined coordinate system, by calculating a moving amount and/or moving speed of a coordinate point due to a first operation;
a calculating step of calculating a moving amount of a coordinate point due to a second operation; and
a time information determining step of determining time information based on the moving amount calculated in the calculating step and the unit quantity determined in the determining step.

51. A non-transitory computer-readable recording medium in which a computer program for causing a computer to detect a movement operation of a coordinate point in a predetermined coordinate system is recorded, the computer program causing the computer to perform steps of:
determining a unit quantity of time corresponding to a moving amount of a coordinate point in the predetermined coordinate system, by calculating a moving amount and/or moving speed of a coordinate point due to a first operation;
calculating a moving amount of a coordinate point due to a second operation; and
determining time information based on the calculated moving amount and the determined unit quantity.
